(19) United States
(12) Patent Application Publication
(10) Pub. No.: US 2004/0199517 A1
(43) Pub. Date: Oct. 7, 2004

(54) Method and system for operating a data warehouse for event management

(76) Inventors: Fabio Casati, Palo Alto, CA (US); Ming-Chien Shan, Saratoga, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/406,770

(22) Filed: Apr. 2, 2003

(51) Int. Cl. G06F 7/00

(52) U.S. Cl. 707/100

(57) ABSTRACT

A method of operating a data warehouse for event management is described. The data warehouse configured as a star schema and having a plurality of tables. The method may include accessing a database having data related to occurred events and actions executed in response to an event, wherein the events and actions are structured according to a star schema and event occurrences and action executions are represented as facts of the star schema. The method may also include generating data related to the events and actions using the star schema, and storing the generated data into the data warehouse.

### FIELD OF THE INVENTION

The disclosure relates to business intelligence. The disclosure also relates to business activity monitoring, on-line analytical processing, and data mining.

### BACKGROUND OF THE INVENTION

Data warehouses, for use in business intelligence are known in the art. Data warehouses are described, for example, in Object-Oriented Data Warehouse Design—Building a Star Schema, by William A. Giovinazzo, published by Prentice Hall PTR, ISBN 0-13-085081-0. Data warehouses can include, for example, an operational environment, an independent data mart, an extraction engine, an extraction store, an extraction log, a central repository, a data store and a dependent data mart. The operational environment may run the daily activities of an organization and can include, for example, order entry and accounts receivable. The operational environment contains raw data that describes the current state of the organization. A data mart focuses on an individual subject area within an organization. An independent data mart receives data from external sources and the operational environment, independently of any data warehouse. An extraction engine retrieves or receives data from the operational environment in any of a variety of possible ways.

The warehouse can be the passive recipient of data from the operational environment or it may actively take data from the operational environment. Data replication can also be used. Data received from the operational environment may be scrubbed and cleansed before it is incorporated into the data warehouse. Scrubbing means converting data from different systems and different formats into a consistent format. Cleansing is the process of removing errors from the data. An extraction store holds extracted data while it awaits transformation and cleansing. An extraction log records the status of the extraction process as operational data is integrated into the data warehouse. The central repository may store all data and metadata for the data warehouse. Metadata is data about data, or the context of the data. A data store may contain the raw data of the data warehouse and can be, for example, either a multidimensional database or a relational database. A dependent data mart, unlike an independent data mart, relies on the data warehouse as the source of its data.

Multi-dimensional data warehouses are one kind of data warehouses that rely on a dimension modeling technique to define the schema for the warehouse. Dimension modeling involves visualizing the data in the warehouse as a multi-dimension data space—each dimension of that space corresponding to a different perspective of looking at the data. Each point in the space, defined by the dimensions, includes measurements for a particular combination of dimensions.

Data in a data warehouse is organized according to a schema. In a dimensional data warehouse, the data is typically organized as a star schema. At the center of a standard star schema is a fact table where data is described in terms of facts, i.e., happenings of interest to be analyzed. Radiating outward from the fact table are multiple dimension tables. Dimension tables include attribute data and the perspectives under which the facts are analyzed. The fact table is connected, or joined, to each of the dimension tables.

The definition and computation of metrics on operational data logged by an IT system without a warehouse may present the following disadvantages: 1) Metric computation may be slower; 2) It may be more difficult to write measure computation queries; 3) Queries may be less reusable, due to the horizontal schema in the warehouse; 4) Metric computation may be based on potentially dirty data; and 5) The business activity monitoring database may become large so that computing queries in real-time becomes very difficult.

At least some embodiments of the present invention may provide improved methods and apparatus for performing business activity monitoring, on-line analytical processing, and data mining, while overcoming the problems identified above.

### DESCRIPTION OF THE DRAWINGS

A more complete appreciation of the present invention and many of the attendant advantages thereof will be readily obtained as the same becomes better understood by reference of the following detailed description when considered in connection with the accompanying drawings.

FIG. 1 is a high-level architecture of the BAM data warehouse according to various embodiments.

FIG. 2A illustrates a schematic for populating, maintaining, and unloading the data warehouse shown in FIG. 1.

FIG. 2B is a flow chart of an exemplary methodology to populate the data warehouse shown in FIG. 1.

FIG. 2C is a flow chart of a method for loading definition tables according to various embodiments.

FIG. 2D is a flow chart of a method for loading instance tables according to various embodiments.

FIG. 3A illustrates a schematic for extracting data from BAM source tables in alternative embodiments.

FIG. 3B illustrates an exemplary schematic of a computer system for performing analysis, monitoring, and control functions of the BAM data warehouse shown in FIG. 1 in accordance with various embodiments.

FIG. 3C illustrates the structuring of the schema used for populating the data warehouse shown in FIG. 1 in accordance with various embodiments.

FIGS. 4-6 show various fact tables according to embodiments of the present invention; and

FIGS. 7-16 show various dimension tables and other tables having information for reporting and performing aggregations according to embodiments of the present invention.

### DETAILED DESCRIPTION OF THE INVENTION

This disclosure of the invention is submitted in furtherance to the constitutional purposes of the U.S. Patent Laws to promote the progress of science and the useful arts.

In at least one embodiment, a method of operating a data warehouse for event management, the data warehouse configured as a star schema and having a plurality of tables is described. The method includes accessing a database having data related to occurred events and actions executed in response to an event, wherein the events and actions are structured according to a star schema and event occurrences and action executions are represented as facts of the star schema. The method also includes generating data related to the events and actions using the star schema, and storing the generated data into the data warehouse. The data warehouse is preferably loaded with data related to events that are in a final state. The method further includes separating data related to events into definition data and instance data, defining database triggers on the definition data to trigger new event or action types, and using the database triggers to identify data for storage into the data warehouse.

In another embodiment, a method of populating a data warehouse with event and action execution data configured in a star schema is described. The method includes extracting data from one or more sources of data into a first database, copying the extracted data into a staging database, processing data stored in the staging database, and populating a second database with the processed data, the populating being performed according to a description of a schema, the schema defining information related to events and actions.

In yet another embodiment, a method of operating a data warehouse for event management, the data warehouse configured as a star schema and having a plurality of tables is described. The method includes accessing a description of a schema, the schema defining the relationships between the tables of the plurality of tables, the description of the schema including information related to event parameters stored in the data warehouse as facts, defining a table for storing event parameters of all events irrespective of event types, providing data related to the events and actions in the data warehouse, generating foreign key relationships among at least some of the tables of the plurality of tables in order to support queries that search for action instances based on an event that generated the instances, and wherein the schema further defines data in terms of facts and dimensions corresponding to the star schema.

In a further embodiment, a method of monitoring activity in a data warehouse configured in a star schema is described. The method includes extracting data from one or more sources of data, storing the extracted data in a staging database, processing data stored in the staging database, populating a second database with the processed data, the populating step being performed according to a description of a schema which defines information related to event parameters stored in the first database as facts, the schema further defining a table for storing event parameters of all events and foreign key relationships between at least some fact tables stored in the first database.

In another embodiment, a business activity monitoring system having a plurality of tables configured in a star schema is described. The system includes a first database, a computer programmable logic for accessing a definition of a schema for accessing the first database, the computer programmable logic further configured for extracting data from one or more data sources and using the definition of the schema for analyzing data stored in the first database for monitoring the business activity, a second database for storing the extracted data, and a processor for processing the data stored in the second database, the processor configured to populate the first database with the processed data according to the definition of the schema, the definition of the schema including information related to event parameters stored in the first database as facts, the schema further defining a table for storing event parameters of all events and foreign key relationships between at least some fact tables stored in the first database.

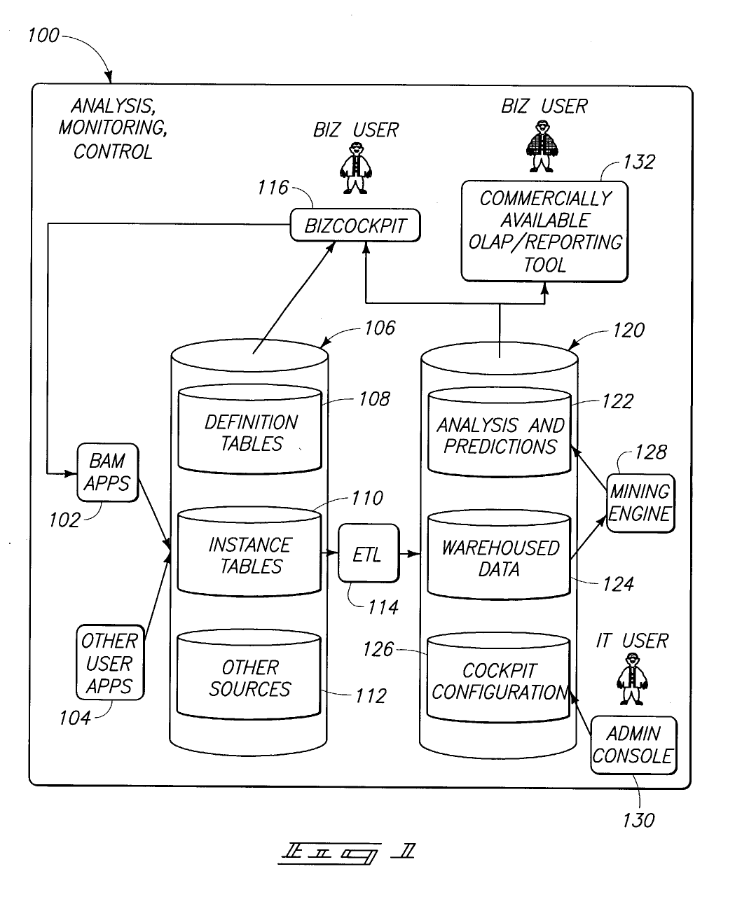

Referring to FIG. 1, a high-level architecture of a business activity monitoring (BAM) system that includes a data warehouse is illustrated in accordance with an exemplary embodiment of the present invention. Data received using BAM applications, identified at 102 or other user applications identified at 104, is stored in a storage device 106 having a database stored therein. The database includes tables 108 and 110 having definition data and instance data, respectively. Definition data stores information about definitions of events, actions, alerts, channels, and other information entered by users administering the system to describe how the BAM system should operate (for example, what to monitor, how to react to an event, whom to alert in case of problems, etc). Tables having definition data typically have a small number of tuples, and change slowly.

Instance data logs the occurrence of event and action instances. Tables having instance data typically include a large number of tuples and are frequently updated. Instance data include generic tables used for storing information about event and action instances, regardless of their type, and also event-specific tables used to log data specific to a certain event instance. Data received from various other sources shown at 112 may also be stored in the database of the storage device 106. Data from the definition table 106, instance table 108, and other sources 112 is periodically loaded into data warehouse 120 by an extraction, transfer, and load (ETL) application 114. The ETL application cleans the data and transforms it into a format suitable for storage in the data warehouse 120 as warehoused data 124.

The warehoused data may be used for analysis, predictions, and identifying correlations of business activity described by such data. The analysis and predictions information identified at 122 may also stored in the data warehouse 120. Various user interfaces (U Is), such as for example, Java/swing, web, or other commercial reporting tools such as Crystal Reports may be used for analysis and predictions of business activity. The analysis and predictions related information may be stored in the data warehouse in a relational format to facilitate its access using a variety of application programs, including third party application programs.

The ETL application is configured by the administration console 130, administered by a user, which defines for example, how often data should be loaded into the data warehouse 120. A data mining application or engine 128 may access the warehoused data for further analysis and forecast predictions of business activity. A business user may also access information stored in the data warehouse 120, using an application tool identified as business cockpit 116, for monitoring the business activity. Also business users may use commercially available reporting tools identified at 132 to access the data warehouse in order to monitor the business activity.

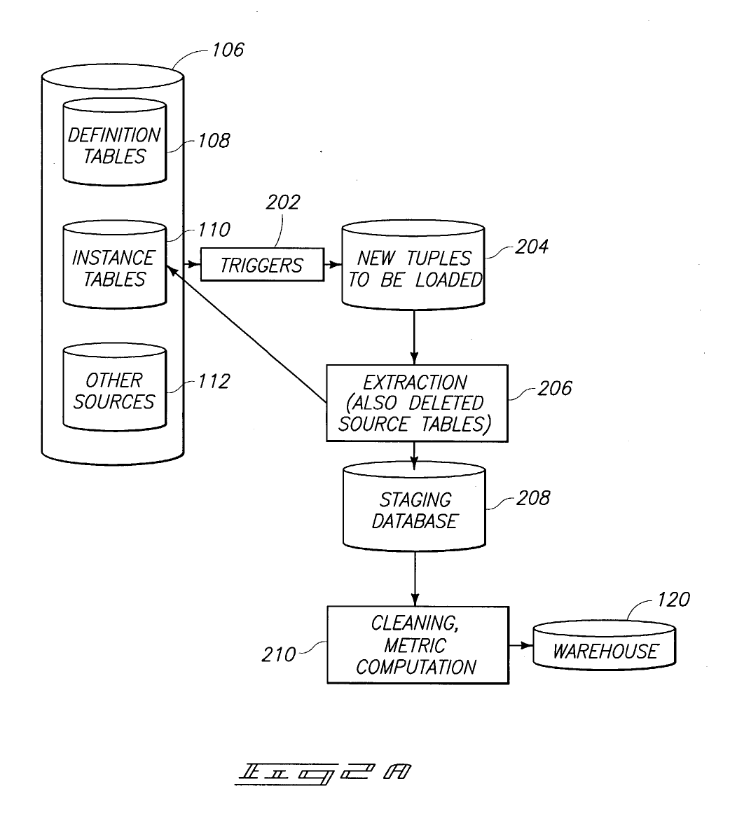

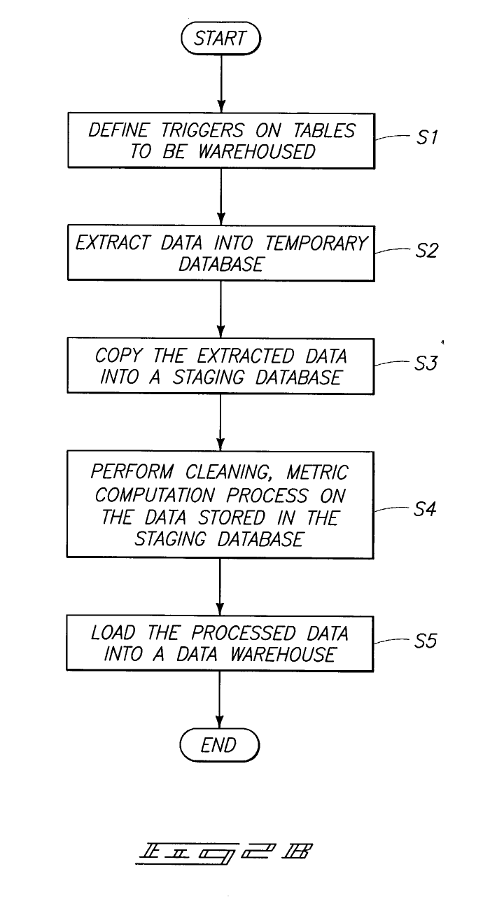

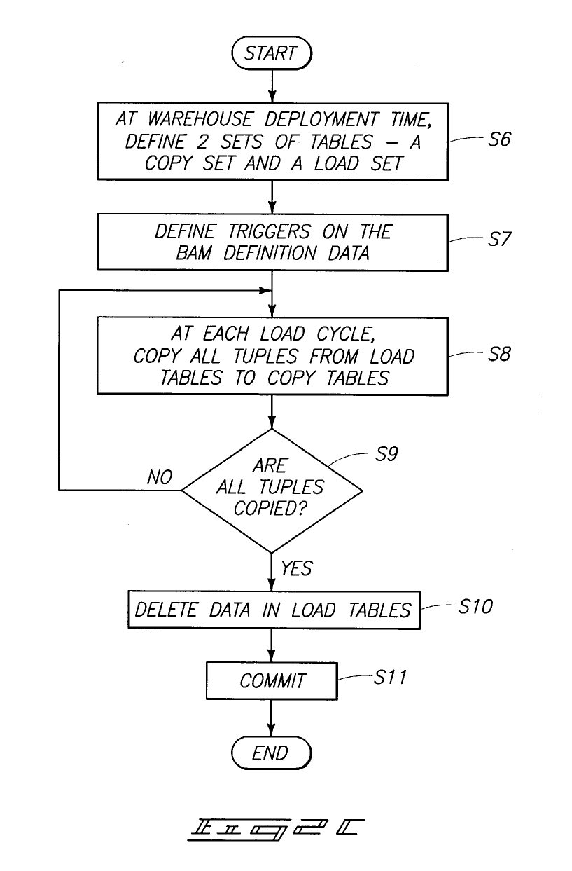

FIG. 2A illustrates a schematic for populating, maintaining, and unloading the warehouse 120 with data obtained from the definition tables, instance tables, or other sources identified in the storage device 106 (FIG. 1). In order to extract data from the storage device 106, triggers 202 are defined on the tables whose data are to be warehoused. Triggers copy tuples related to events that are in their final state to a temporary database 204. An event in a final state is an event logged by the BAM system (for example, such as an order or a payment transaction) that has been processed by the BAM infrastructure, so that all required actions have been successfully performed or the processing returned an error. Then, at warehouse loading time, data may be extracted from the temporary database 204 and copied into a staging database 208 to perform further cleaning and other computations of some metrics and eventually transferred into the data warehouse 120. The warehouse loading process may also delete tuples in a source database, if such information is not needed by the BAM applications 102 (FIG. 1).

The above procedure of populating, maintaining, and unloading minimizes the impact on the BAM database in storage device 106 by locking tuples for the shortest possible time, and by removing tuples that are not needed by the BAM system, thus keeping the tuples small in order to enable faster BAM operations. The above procedure also optimizes the process of populating the data warehouse. The data warehouse further includes metadata in order to keep track of the data that is loaded at each cycle, and also to maintain correspondence between system-generated identifiers, generated for ease of maintenance of the data, in the data warehouse 120 and identifiers in a source system from which data is extracted and loaded into the data warehouse.

FIG. 2B is a flow chart of an exemplary methodology to populate the data warehouse, identified in FIG. 1, according one embodiment. At a step S1, in order to extract data from the storage device 106 (FIG. 1), triggers are defined on the tables to be warehoused. In a step S2, data is extracted from the storage device 106 into a temporary database. In a step S3, data from the temporary database is copied into a staging database. Processing data directly from the temporary database causes performance degradation, as it would need to lock definition and instance tables, thereby delaying the execution of the trigger and ultimately delaying the execution of on-line transactions on BAM tables with critical execution times. In a step S4, further processing, such as for example, cleaning and other metric computations on the data stored in the staging database are performed. In step S6, the processed data is loaded into the data warehouse 120 (FIG. 1).

Loading Definition Tables

Definition tables are loaded by the following exemplary process. At deployment time:

Define two sets of tables—one being the copy set, which typically includes one table called copy_T for every definition table T, and the other one being the load set that includes a load_T table for each T table. Both the load table and the copy table have a similar structure of the original table T (with the addition of a modification time attribute); and

Define triggers on the BAM definition data (i.e., data describing the characteristics of events and actions types, as opposed to instance data, which is data representing actual occurrences of events and actions), to copy insertions and modifications made on the original table T to the copy_T table, also inserting the modification time.

Run-Time, at Each Load Cycle

Copy all tuples from load tables to copy tables;

Delete load tables. It is desirable to truncate the tables instead of using a delete feature if new actions/events are defined often. It will however be appreciated that the truncating step implicitly commits the transaction;

Commit;

Load data into the warehouse dimensions (after cleaning data converting formats, etc.) and into metadata structures to keep track of data that has been loaded;

Commit.

The relationships between the dimensions in the star schema are described within a fact table. The star schema joins the single-dimensional dimension tables to one another, thus providing a multidimensional analysis space within the relational database. The primary key of the fact table is a composite of the dimension-table keys. The keys included in the primary key of the fact table define how a record or a set of records in one dimension is related to the set of records in another dimension.

A star schema allows a data warehouse architect to create a multidimensional space within a relational database. Dimensions are implemented as tables with records having complete descriptions of objects that make the dimensions. The fact table holds the single-dimensioned dimension tables together into an analysis space.

FIG. 2C is a flow chart of a method for loading definition tables according to an exemplary embodiment of the present invention. At a step S6, at a warehouse deployment time, two sets of tables, such as for example, a copy set and a load set are defined. At step S7, triggers are defined on the BAM definition data in order to copy insertions and modifications made on an original table T to the copy table. At step S8, at each load cycle, all the tuples are copied from load tables to copy tables. At step S9, an inquiry is made to determine whether or not all the tuples are copied. If true, the process proceeds to step S10. Otherwise, the process loops to step S8. At step Sb0, the load tables are deleted, and the process commits for loading data into the data warehouse.

Loading Instance Tables

Instance tables are loaded after loading the definition tables, by the following exemplary process. At deployment time, define the load set, that includes a load_T tables for each T table. The load tables have similar structure of the original table T (with the addition of a modification time attribute); and

Optionally, define the archive set that includes an archive_T table for each T table. The archive table has a similar structure of the original table T (with the addition of a modification time attribute). The archive table and the archive set are desirable if users intend to archive logged data independently of the warehouse. Such tables are desirable because the data warehouse deletes instance tuples upon loading.

Run-Time, at Each Load Cycle

In this step, all tuples about events in the final state (completed or in error) are copied from an event_instance table (written by the on-line BAM system) into a load_event_instance table;

Next, all other instance data (from the action_instance and the other event-specific tables) are copied into analogous “load” tables (e.g., load_action_instance). The copying step is limited to those tuples that are related to events in load_event_instance (For example, complete actions are not copied. Instead, actions that refer to completed or error events are copied);

Subsequently, data in source (BAM) tables that has been copied to the load tables are deleted. It is desirable to truncate the tables instead of using a delete feature if new actions/event instances are defined often. It will however be appreciated that the truncating step implicitly commits the transaction, and can therefore cause data loss in case of failures occurring when loading data;

The process commits after the source BAM tables are deleted;

Next, data from load tables are copied into archive tables. Subsequent steps include loading data into the warehouse facts (after cleaning data, converting formats, etc) and into metadata structures to keep track of what has been loaded; and

Commit.

FIG. 2D is a flow chart of a method for loading instance tables according to an exemplary embodiment of the present invention. At a step S12, and at deployment time, define a load set having a load table for each original table. At step S13, optionally define an archive set having an archive table for each original table. At step S14, and at run time, for each load cycle, copy all tuples about event in a final state into a load_event_instance table. At step S15, copy all other instance data related to events in a final state from action_instance and other tables into analogous load tables. At step S16, an inquiry is made to determine if all tuples are copied. If true, the process proceeds to step S17, else the process loops to step S14. At step S17, source BAM tables are deleted and data from the load tables is copied into the archive tables at step S18. At step S19, the process commits for loading data into the data warehouse.

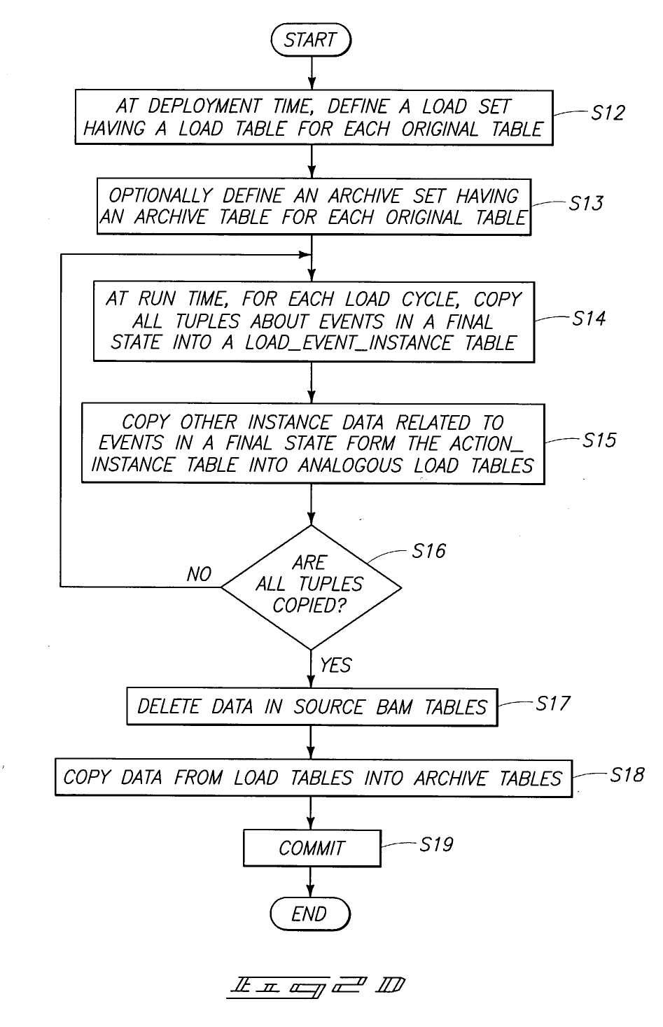

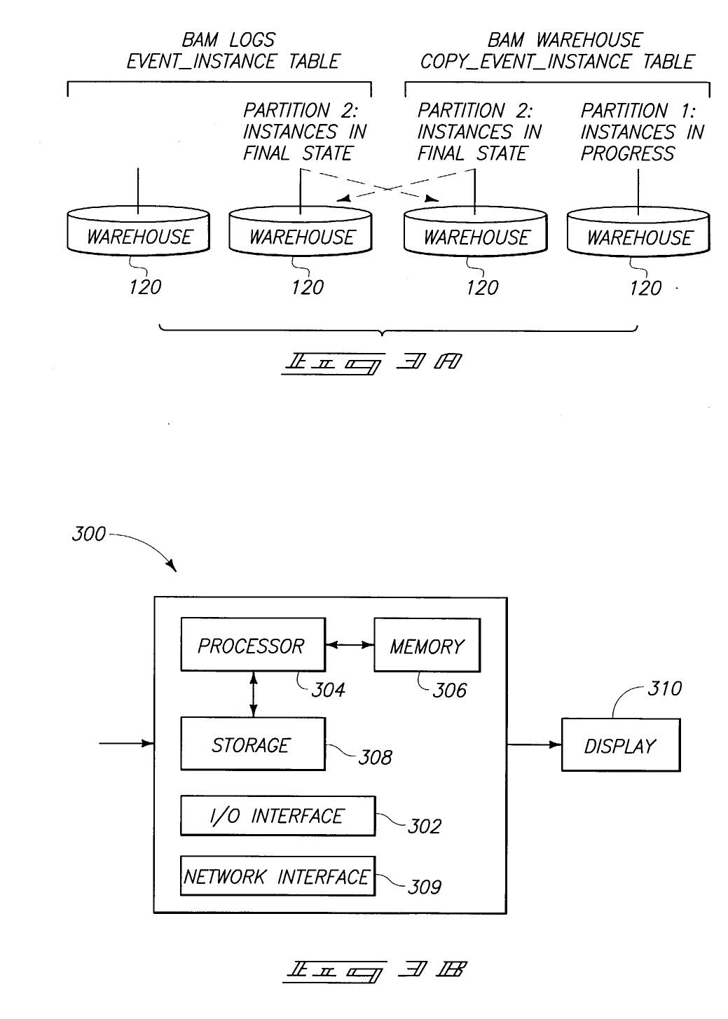

FIG. 3A illustrates a schematic for extracting data from BAM source tables in another exemplary embodiment of the present invention. Faster data extraction from the BAM source tables may be achieved by partitioning the event_instance table on the event states, and then swapping data from the partitions instead of copying and deleting data. In this way, the event_instance will have one partition that includes all data related to event instances in the final state. That is, in order to extract data from the BAM tables and move it to the temporary database, it would be sufficient to take the whole partition and exchange it with an empty one. This process is virtually instantaneous in most systems, and therefore ensures fast data loading with minimal impact on on-line transactions, since there would be no need of locking any data structure.

FIG. 3B illustrates an exemplary schematic of a computer system 300 for performing analysis, monitoring, and control functions of the BAM data warehouse system illustrated in FIG. 1. The computer system 300 may be used by the IT user (FIG. 1) in order to administer warehousing of the data into data warehouse 120, or by a business user to monitor the business activity related to the warehoused data. The storage device 308 of the computer system 300 may be loaded with one or more application programs in order to execute the above noted administration and monitoring functions. The computer system also includes an I/O interface 302, a processor 304 for controlling and processing the various functions of the computer system, a memory 306, a network interface device 309, and a display device 310 for displaying the processed data.

FIG. 3C illustrates the structuring of the schema used for storing data in the data warehouse 120 (FIG. 1), and wherein database tables are represented by boxes. The boxes highlighted using thick solid lines represent fact tables, while the boxes represented by the dashed lines represent the dimension tables, and the other boxes that are neither fact tables nor dimensions represent other accessory tables. For example, boxes identified as 402, 404, and 406, respectively are the fact tables, and boxes identified as 408, 410, 412, 414, 416, and 418, respectively are dimension tables, and boxes identified as 420, 422, and 424 represent other accessory tables that are neither fact tables nor dimension tables. Lines connecting each of the boxes represent foreign key relationships. For example, the side of a line ending with a ball at a box denotes a table where the primary key resides, while the side of the line ending at a box and without the ball denotes the table where the foreign key resides. The structuring of the data warehouse, and specifically the subdivision in facts and dimensions as illustrated in FIG. 3C enables querying event and action data by event type, action type, status, event parameter, time, and application triggering the event. Structuring the schema as shown in FIG. 3C enables queries to be written easily and executed quickly by any modern relational database management system, such as for example Oracle Server by Oracle Corp. of Redwood Shores, Calif.

In most event-based systems, events have parameters. For example, an order event includes a parameter denoting the customer name and the product ordered. The event parameters are stored in the data warehouse 120 (FIG. 1) as facts, and that a single table stores all event parameters of all events—regardless of event types. Providing a single table for storing all event parameters simplifies query definition as all queries on event data are based on the same table. In the absence of this approach, a different query may be required to retrieve data for different events. Furthermore, unlike common data warehouses schema, there exists a foreign key relationship among fact tables 402, 404, and 406, respectively. Having such foreign key relationships is helpful to support queries that search for action instances based on an event that generated such action instances, as well as queries that search for event parameters.

As mentioned above, the BAM warehouse database is structured according to a star schema design, where data are described in terms of “facts”, and “dimensions.” A design based on a star schema enables multidimensional analysis (i.e., the analysis of facts seen from different perspectives) and allows the use of many query optimization techniques. BAM data warehouse includes the following facts, basically corresponding to BAM instance data:

W_Event_Instances

W_Event_Data

W_Action_Instances

These facts may be analyzed based on the following exemplary dimensions: Events, Actions, Application, Endpoint, Status, Type, Category and Time.

Events focus on facts related to a specific event (and possibly a specific version), or to a set of events, or to events of a given type, etc.

Actions focus on facts related to a specific action (and possibly a specific version of an action), or to a set of actions, or to actions of a given type, etc.

Application focuses on facts related to events sent by a specific application.

Endpoint focuses on facts related to actions sent to a specific endpoint.

Status focuses on facts related to events and actions in a certain state.

Type focuses on facts related to events and actions of a certain type.

Category focuses on facts related to events and actions of a certain category.

Time focuses on facts occurred in a certain (fiscal or calendar) time window, or on specific days, weekdays, or hours of the day.

The data warehouse 120 (FIG. 1) also includes other tables that may be needed for reporting (e.g., WUSER). Such tables are neither fact tables nor dimension tables.

The data warehouse 120 (FIG. 1) includes an event instance fact table that collects data about event instances, an exemplary representation of which is illustrated in FIG. 4. All the event instances generated in BAM system and related to an EVENT_ERROR or EVENT_COMPLETED categories (i.e., related to events in a final state) are moved to the data warehouse 120. It will be appreciated that the table shown in FIG. 4 is merely exemplary and represented in a simple form than what it actually is in order to better explain the inventive aspects.

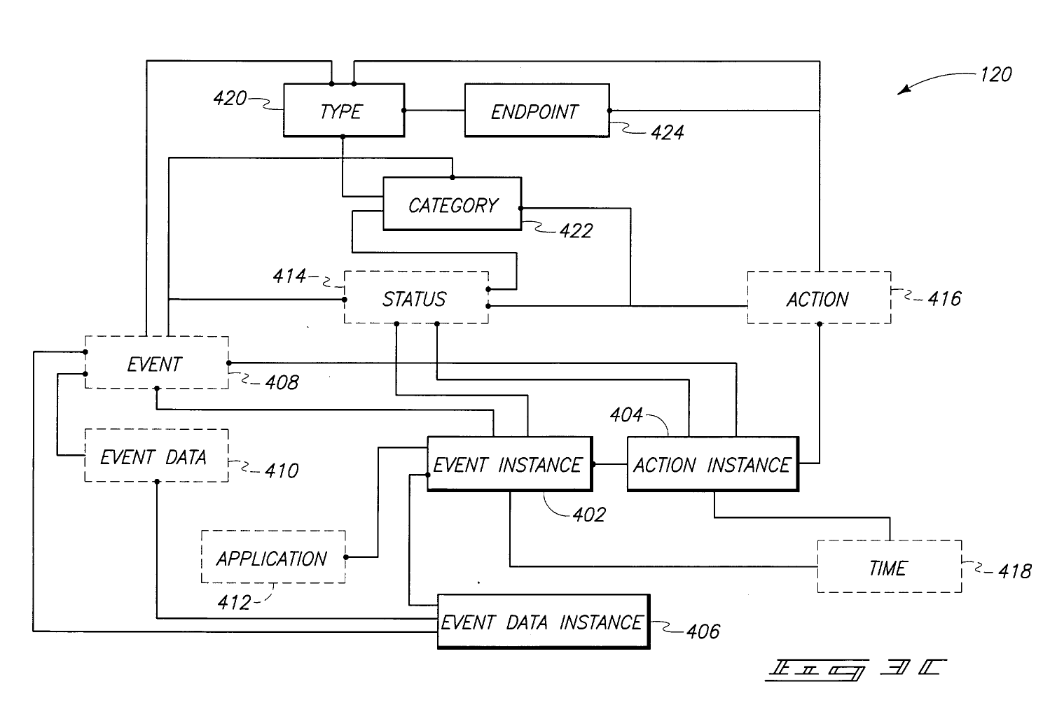

The data warehouse also includes an action instance fact table as shown in exemplary FIG. 5. Typically, this table includes data useful for computing reports related to monitoring of a business activity. All the action instances generated in the BAM monitoring system (FIG. 1) are typically moved to the data warehouse 120 once the event the caused their execution is assured to be in a final state.

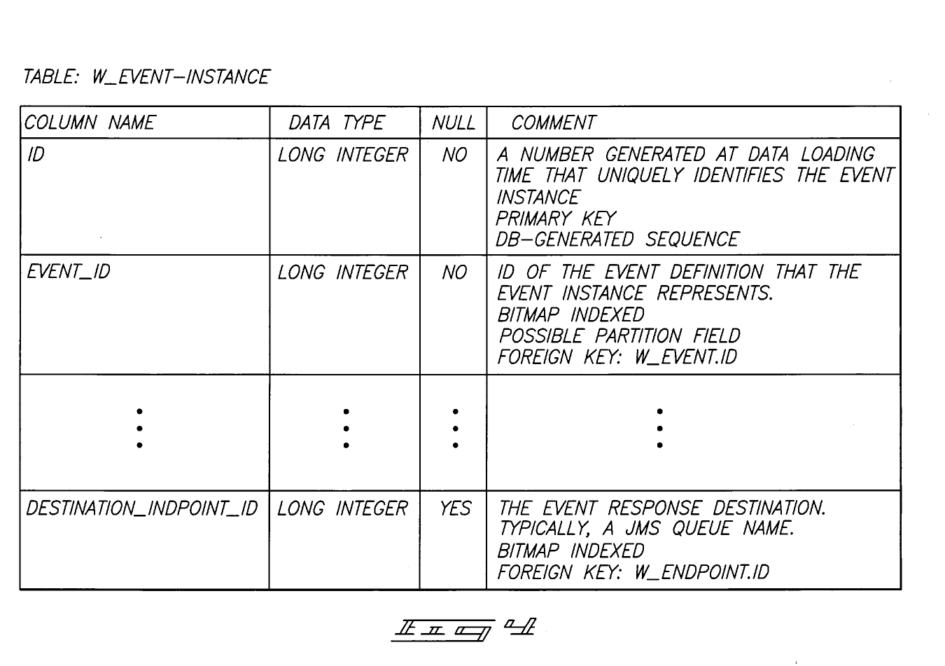

Referring to FIG. 6, there is shown an exemplary event_data_instance_table which includes parameter values for all occurred events.

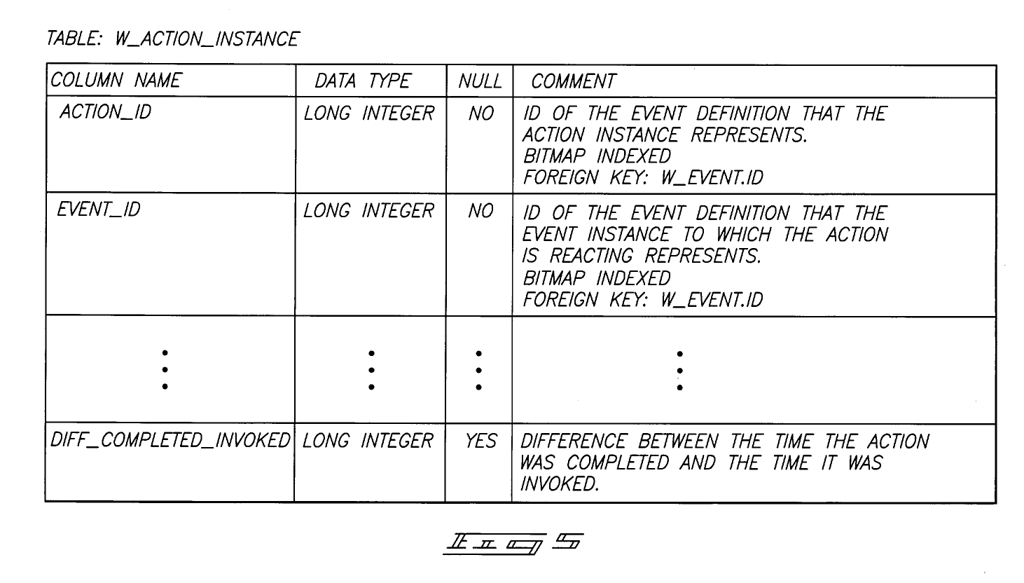

FIGS. 8 through 16 generally illustrate the dimensions of the data warehouse, as well as other tables that contain information useful for reporting, and in particular for performing aggregation functions.

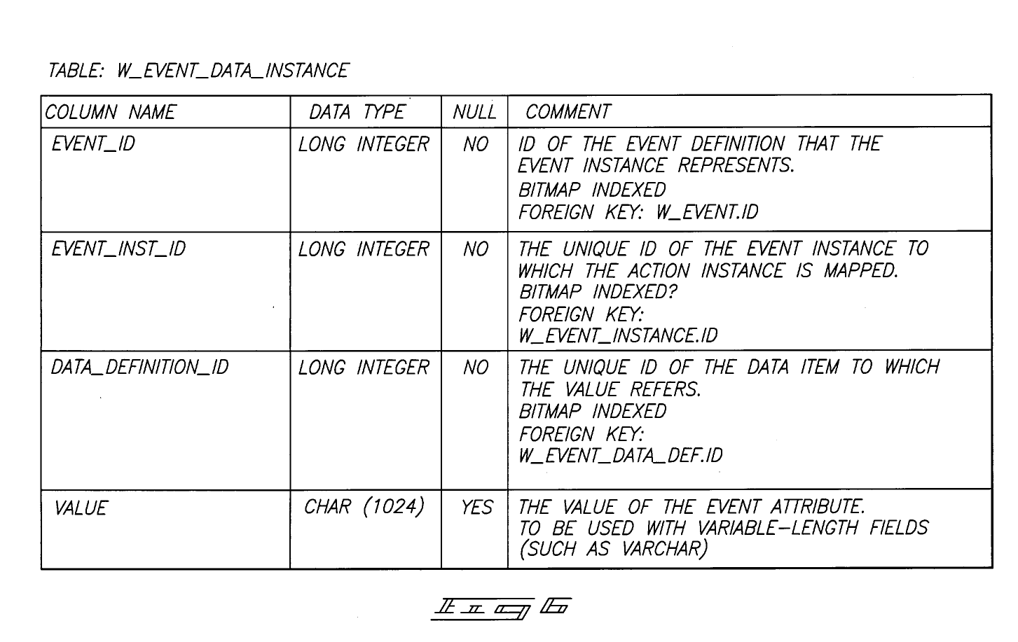

FIG. 7 is an exemplary W_EVENT table wherein all event definitions used by BAM system are stored therein. FIG. 8 is an exemplary ACTION table wherein all action definitions by the BAM system are stored therein. FIG. 9 is an exemplary ALERT_RECIPIENT table which includes an alert notification sent to all the users subscribing to such alert notification feature. Users may choose different set of channels through which they prefer to receive each alert that a user subscribed for. All user definitions in the BAM system are stored in the W_USERS table as shown in exemplary FIG. 10.

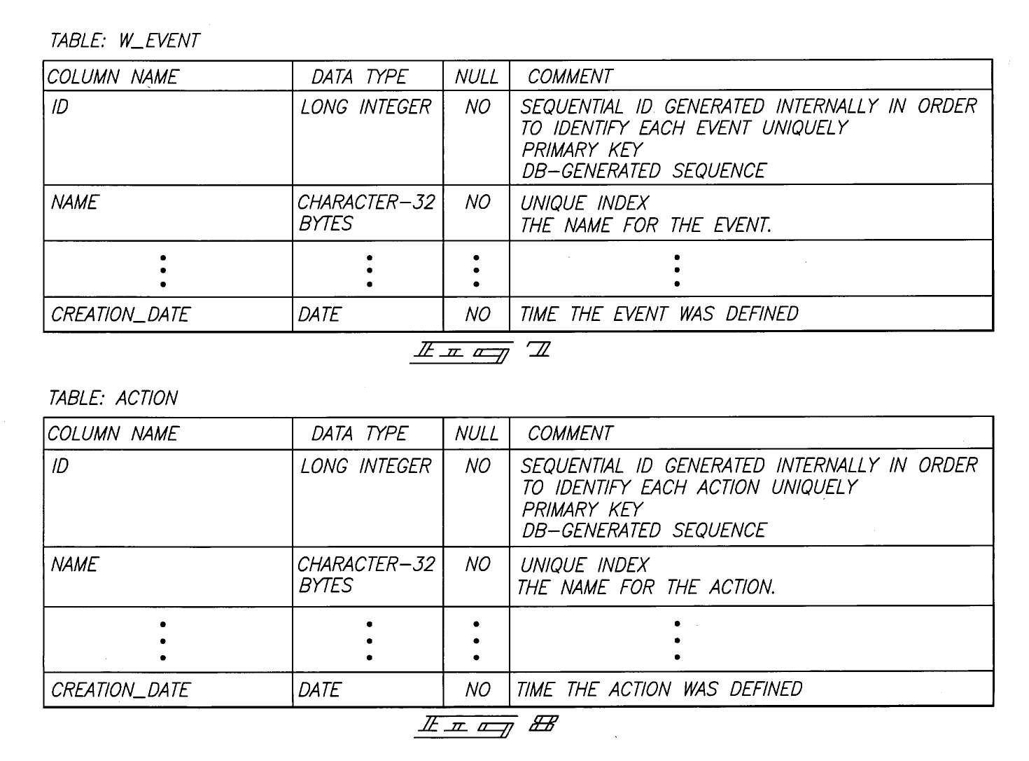

FIG. 11 shows an exemplary TIME table that lists all different time instances, rounded to the minute, in which a fact occurred. Time instances may also be decomposed by storing the year, month, and day to which they correspond along with other relevant characteristics. Users are provided with an option to define fiscal dates.

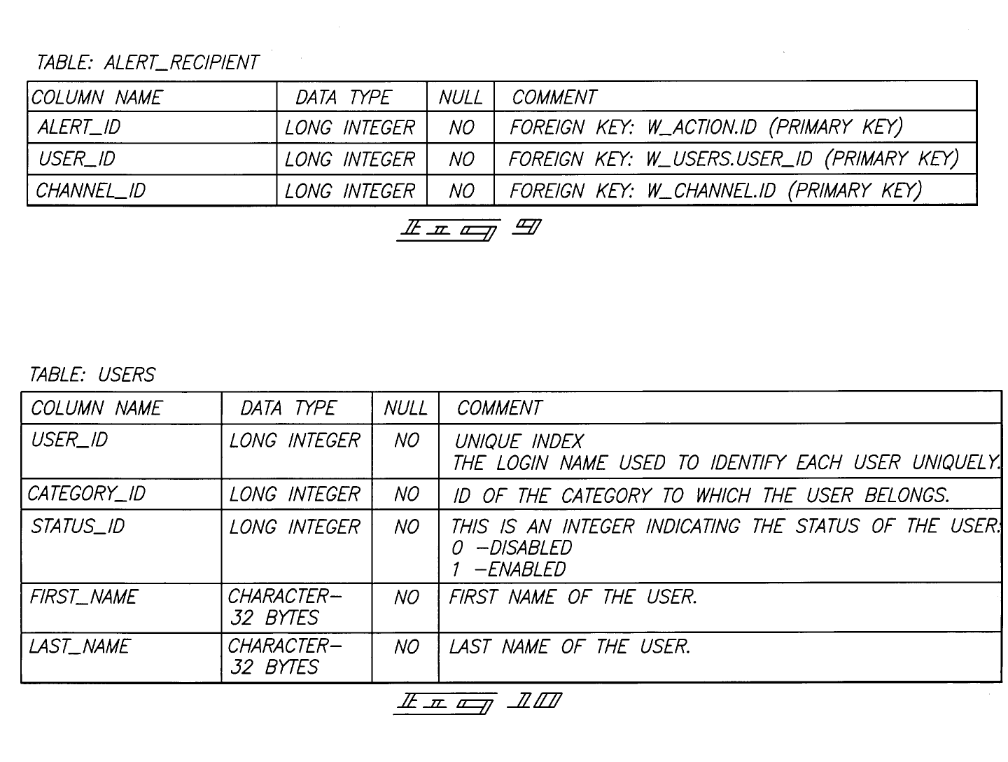

FIG. 12 shows a table having information about event-specific data. This table includes one tuple for each attribute of each event.

FIG. 13 shows a table that defines a set of states in which BAM objects can reside. For example, event instances may reside in the EVENT_RECEIVED or EVENT_ERROR states, and categories can be ENABLED or DISABLED, etc. Having a single table in which all different states can be defined and stored makes the structure of the database simpler, thus enabling dynamic aggregations when reporting, based on the state.

For example, the status table may include the following sample contents:

0 Disabled

1 Enabled

100 (EVENT_RECIVED)

101 (EVENT_ERROR)

102 (EVENT_ALL_ACTIONS_INVOKED)

104 (EVENT_COMPLETED)

200 (ACTION_INVOKED)

201 (ACTION_ERROR)

202 (ACTION_COMPLETED)

203 (ACTION_TIME_OUT)

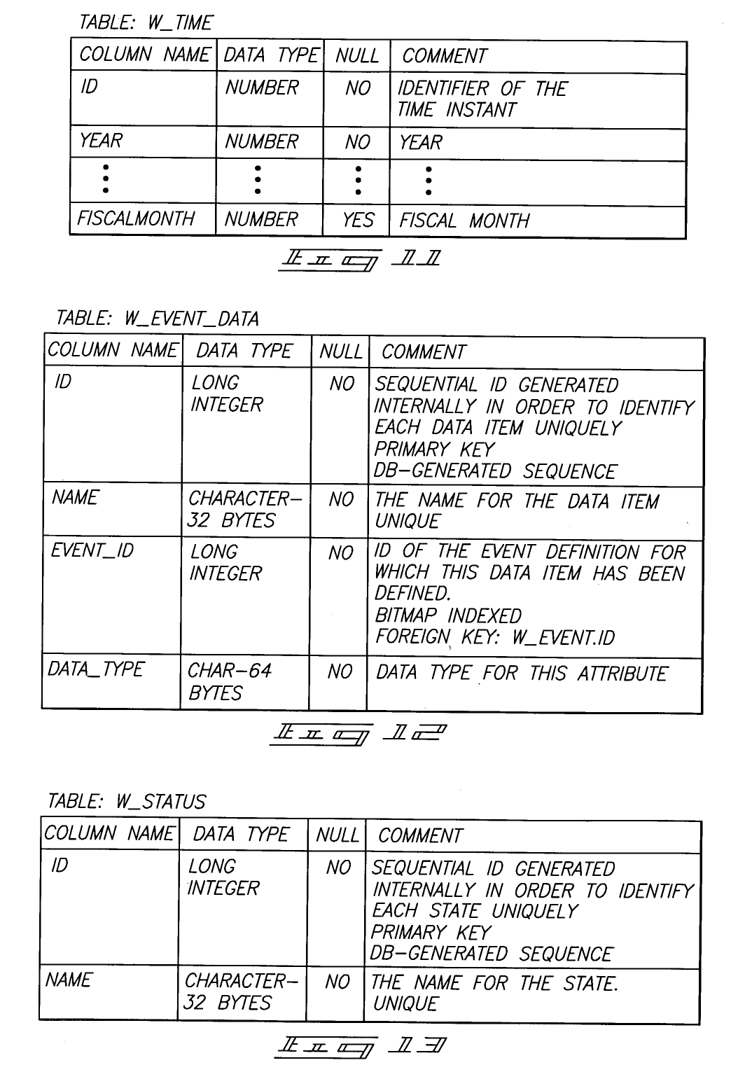

FIG. 14 shows an exemplary table that includes type definition information used for qualifying the characteristics of various BAM objects. As with the STATES table, having a TYPE table makes the database structure simpler, thus enabling dynamic aggregations.

Some of the example TYPES used through the BAM system are shown below. The TYPE table may also be made a part of the BAM schema, and referred throughout by the different BAM tables. It will be appreciated that the notations below are merely exemplary, and therefore not to be construed as limiting the inventive concept.

Integer indicating the definition type this category applies to:

1—Event

2—Action

3—Alert

Integer indicating the event type:

1—External

2—Internal

3—Scheduled

Integer indicating the severity of the event:

0—Normal

1—Low

2—Medium

3—High

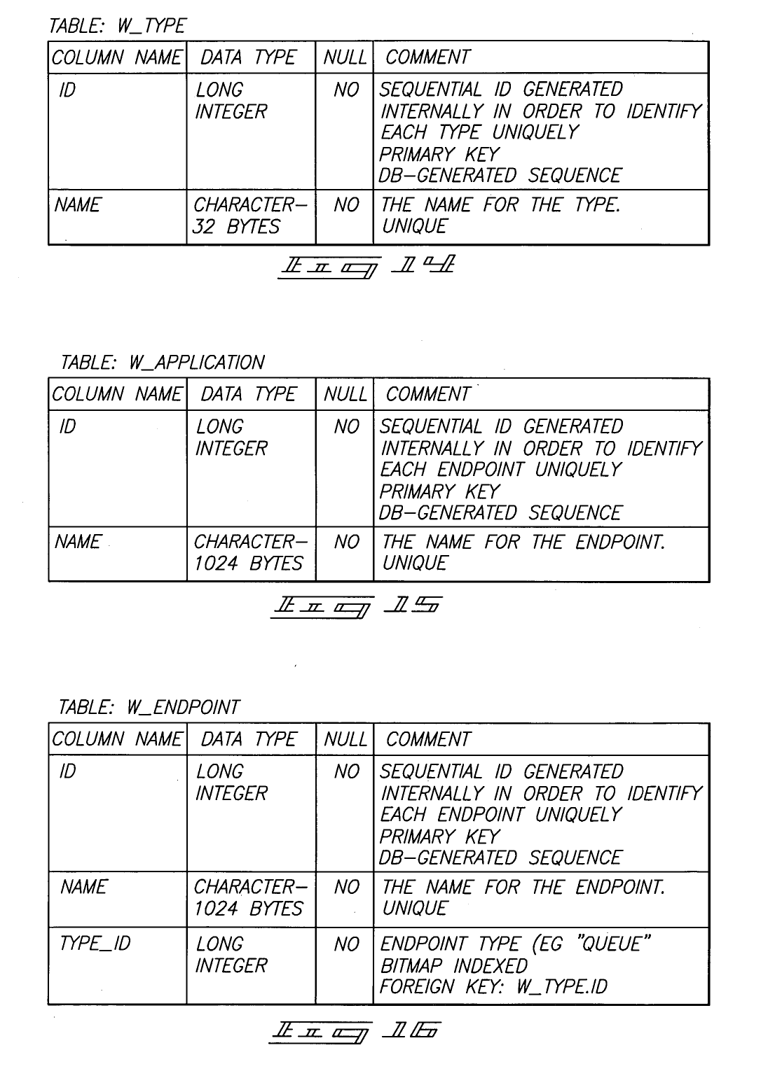

FIG. 15 shows an exemplary table that defines the different applications. In this table, IDs are referred by the W_event_instance table in order to link an external application to the event instance. FIG. 16 shows a table having information related to sources of targets of messages. BAM has the notion of endpoint, to denote sources or targets of messages.

In some embodiments, the present invention may include:

1) Storing event, action, and other BAM data in the warehouse enables easier definition and faster computation of reports; 2) BAM data can be cleaned from errors and inconsistencies upon load; 3) data is structured in a way that is optimized for the analysis, both from a performance perspective and from a usability perspective (i.e., the warehouse schema makes it easier to write queries); 4) a smaller number of queries is needed to compute metrics, as the warehouse schema has features (such as having all event parameters in a single table) that makes the data structure independent from the event and action types; 5) reports can be computed at warehouse loading time and based on the staging data, rather than being computed out of the whole warehoused data; and 6) data loaded into the warehouse are removed from the on-line database, so that computations of real-time reports from the on-line database can run faster; and 7) enables performing complex operations on the warehouse (such as causal analysis) without impacting applications that are logging data, and whose operations cannot be delayed.

In compliance with the patent statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of operating a data warehouse for event management, the data warehouse configured as a star schema and having a plurality of tables, the method comprising:
accessing a description of a schema, the schema defining the relationships between the tables of the plurality of tables, the description of the schema including information related to event parameters stored in the data warehouse as facts;
defining a table for storing event parameters of all events irrespective of event types;
providing data related to the events and actions in the data warehouse;
generating foreign key relationships among at least some of the tables of the plurality of tables in order to support queries that search for action instances based on an event that generated the instances; and
wherein the schema further defines data in terms of facts and dimensions corresponding to the star schema.

2. The method as in claim 1, further comprising:
generating a set of commands to create the plurality of tables, the set of commands being generated from the description of the schema; and
executing the set of commands to generate the plurality of tables, wherein the set of commands further includes commands for accessing and manipulating the plurality of tables.

3. The method as in claim 1, further comprising:
analyzing the facts based on a set of dimensions, the dimensions being perspectives under which the facts are analyzed.

4. The method as in claim 3, wherein the set of dimensions include tables having data related to events, actions, application, endpoint, status, type, category, and time features.

5. The method as in claim 3, wherein the plurality of tables include tables having data for notifying data warehouse activity to a user.

6. The method as in claim 3, further comprising:
transferring event data having errors or completed events to the data warehouse for analysis.

7. The method as in claim 3, further comprising:
transferring data related to action instances to the data warehouse once status of the action instances is determined to be in a final state for analysis.

8. The method as in claim 3, further comprising:
storing event definitions used by the data warehouse in an event table among the plurality of tables.

9. The method as in claim 8, further comprising:
storing action definitions used by the data warehouse in an action table among the plurality of tables.

10. The method as in claim 9, further comprising:
notifying a user subscribed to the data warehouse about occurrence of an event of interest to the user.

11. A method of monitoring activity in a data warehouse configured in a star schema, the method comprising:
extracting data from one or more sources of data;
storing the extracted data in a staging database;
processing data stored in the staging database; and
populating a second database with the processed data, the populating step being performed according to a description of a schema which defines information related to event parameters stored in the first database as facts, the schema further defining a table for storing event parameters of all events and foreign key relationships between at least some fact tables stored in the first database.

12. The method as in claim 11, further comprising:
generating a set of commands to create a plurality of tables, the set of commands being generated from a description of the star schema; and
executing the set of commands to generate the plurality of tables, wherein the set of commands further includes commands for accessing and manipulating the plurality of tables.

13. The method as in claim 11, further comprising:
analyzing facts based on a set of dimensions, the dimensions being perspectives under which the facts are analyzed.

14. The method as in claim 13, wherein the set of dimensions include tables having data configured to query action and event data by events, actions, application, endpoint, status, type, category, and time features.

15. The method as in claim 12, wherein the plurality of tables include tables having data for reporting data warehouse activity to a user.

16. The method as in claim 13, further comprising:
transferring event data having errors or complete events to the data warehouse for analysis.

17. The method as in claim 13, further comprising:
transferring data related to action instances to the data warehouse once status of the action instances is determined to be in a final state for analysis.

18. The method as in claim 11, wherein the one or more sources include data sources having definition data and instance data.

19. The method as in claim 11, wherein the extracting step is performed by defining triggers on the tables having data that is desired to be stored in the data warehouse.

20. A business activity monitoring system having a plurality of tables configured in a star schema, comprising:
a first database;
a computer programmable logic for accessing a definition of a schema for accessing the first database, the computer programmable logic further configured for extracting data from one or more data sources and using the definition of the schema for analyzing data stored in the first database for monitoring the business activity;
a second database for storing the extracted data; and
a processor for processing the data stored in the second database, the processor configured to populate the first database with the processed data according to the definition of the schema, the definition of the schema including information related to event parameters stored in the first database as facts, the schema further defining a table for storing event parameters of all events and foreign key relationships between at least some fact tables stored in the first database.

21. The system as in claim 20, wherein the definition of the schema includes a definition of a fact table, one or more dimensions, and a set of relations between the fact table and the one or more dimensions that correspond to the star schema.

22. The system as in claim 20, wherein the schema is used to store and analyze event and action data stored in the first database.

23. An apparatus for operating a data warehouse for event management, the data warehouse configured as a star schema and having a plurality of tables, the apparatus comprising:
means for accessing a description of a schema, the schema defining the relationships between the tables of the plurality of tables, the description of the schema including information related to event parameters stored in the data warehouse as facts;
means for defining a table for storing event parameters of all events irrespective of event types;
means for providing data related to the events and actions in the data warehouse;
means for generating foreign key relationships among at least some of the tables of the plurality of tables in order to support queries that search for action instances based on an event that generated the instances; and
wherein the schema further defines data in terms of facts and dimensions corresponding to the star schema.

24. The apparatus as in claim 23, further comprises:
means for generating a set of commands to create the plurality of tables, the set of commands being generated from the description of the schema; and
means for executing the set of commands to generate the plurality of tables, wherein the set of commands further includes commands for accessing and manipulating the plurality of tables.

25. The apparatus as in claim 24, further comprises:
means for transferring event data having errors or completed events to the data warehouse for analysis;
means for analyzing the facts based on a set of dimensions, the dimensions being perspectives under which the facts are analyzed;
means for transferring data related to action instances to the data warehouse once status of the action instances is determined to be in a final state for analysis.

26. The apparatus as in claim 25, wherein the set of dimensions include tables having data related to events, actions, application, endpoint, status, type, category, and time features, and the plurality of tables include tables having data for reporting to a user.

27. The apparatus as in claim 25, further comprises:
means for storing event definitions used by the data warehouse in an event table among the plurality of tables;
means for storing action definitions used by the data warehouse in an action table among the plurality of tables; and
means for notifying a user subscribed to the data warehouse about occurrence of an event of interest to the user.

28. A method of operating a data warehouse for event management, the data warehouse configured as a star schema and having a plurality of tables, the method comprising:
accessing a database having data related to occurred events and actions executed in response to an event, wherein the events and actions are structured according to a star schema and event occurrences and action executions are represented as facts of the star schema;
generating data related to the events and actions using the star schema; and
storing the generated data into the data warehouse.

29. The method as in claim 28, further comprising:
loading the data warehouse with data related to events that are in a final state;
separating data related to events into definition data and instance data;
defining database triggers on the definition data to trigger new event or action types; and
using the database triggers to identify data for storage into the data warehouse.

30. A method of populating a data warehouse with event and action execution data configured in a star schema, comprising:
extracting data from one or more sources of data into a first database;
copying the extracted data into a staging database;
processing data stored in the staging database; and
populating a second database with the processed data, the populating being performed according to a description of a schema, the schema defining information related to events and actions.

31. The method as in claim 30, wherein the extracting is performed by
defining triggers that capture insertion of new data of interest into the first database.

32. A method of monitoring activity in a data warehouse configured in a star schema, the method comprising:
extracting data from one or more data sources including from an instance table, the extraction step from the instance table includes:
partitioning the instance table on event states; and
swapping data from the partitioned tables;
storing the extracted data in a staging database;
processing data stored in the staging database; and
populating a second database with the processed data, the populating step being performed according to a description of a schema which defines information related to event parameters stored in the first database as facts, the schema further defining a table for storing event parameters of all events and foreign key relationships between at least some fact tables stored in the first database.

33. The method as in claim 32, wherein the extracting is performed by defining triggers that capture insertion of new data of interest into a temporary database.

34. A method of operating a data warehouse for event management,
the data warehouse configured as a star schema and having a plurality of tables, the method comprising:
providing a schema;
defining the schema, wherein definition of the schema includes:
information related to event parameters stored in the data warehouse as facts;
relationships between the plurality of tables; and
data described in terms of facts and dimensions corresponding to the star schema;
accessing the schema.

35. The method as in claim 34, wherein:
the schema further defines a table for storing event parameters of all events and foreign key relationships between at least some fact tables.
